(19) United States
(12) Patent Application Publication
(10) Pub. No.: US 2013/0127768 A1
(43) Pub. Date: May 23, 2013

(54) DISPLAY APPARATUS AND METHOD

(71) Applicant: Hannu Aulis Haapakoski, Salo (FI)

(72) Inventor: Hannu Aulis Haapakoski, Salo (FI)

(73) Assignee: NOKIA CORPORATION, Espoo (FI)

(21) Appl. No.: 13/298,854

(22) Filed: Nov. 17, 2011

(51) Int. Cl. G06F 3/044

(52) U.S. Cl. 345/174

(57) ABSTRACT

An apparatus and a method is provided. The apparatus includes: a touch sensitive layer; a conductive layer configured to shield, at least in part, the touch sensitive layer from electromagnetic interference generated by a display panel; and one or more polarizers, situated at least partially between the touch sensitive layer and the conductive layer, configured to intercept light that is directed towards a viewer of the display panel after being reflected by the conductive layer.

### TECHNOLOGICAL FIELD

Embodiments of the present invention relate to a display apparatus and method. In particular, they relate to a display apparatus comprising a touch sensitive layer.

### BACKGROUND

A touch sensitive display apparatus may comprise a display panel, multiple polarizers and a touch sensitive layer. A conductive layer may be positioned between the display panel and the touch sensitive layer, such that the conductive layer shields the touch sensitive layer from electromagnetic interference generated by the display panel when it is refreshed.

The optical performance of such a display apparatus is not, however, optimal because the conductive layer may also reflect incoming ambient light towards a viewer of the display apparatus.

### BRIEF SUMMARY

According to various, but not necessarily all, embodiments of the invention there is provided an apparatus, comprising: a touch sensitive layer; a conductive layer configured to shield, at least in part, the touch sensitive layer from electromagnetic interference generated by a display panel; and one or more polarizers, situated at least partially between the touch sensitive layer and the conductive layer, configured to intercept light that is directed towards a viewer of the display panel after being reflected by the conductive layer.

According to various, but not necessarily all, embodiments of the invention there is provided a method, comprising: using a conductive layer to shield, at least in part, a touch sensitive layer from electromagnetic interference generated by a display panel; and using one or more polarizers, situated at least partially between the touch sensitive layer and the conductive layer, to intercept light that is directed towards a viewer of the display panel after being reflected by the conductive layer.

According to various, but not necessarily all, embodiments of the invention there is provided an apparatus, comprising: touch sensing means; shielding means for shielding, at least in part, the touch sensing means from electromagnetic interference generated by a display panel; and means for intercepting light that is directed towards a viewer of the display panel after being reflected by the shielding means, wherein the means for intercepting light is situated at least partially between the touch sensitive layer and the conductive layer.

### BRIEF DESCRIPTION

For a better understanding of various examples of embodiments of the present invention reference will now be made by way of example only to the accompanying drawings in which:

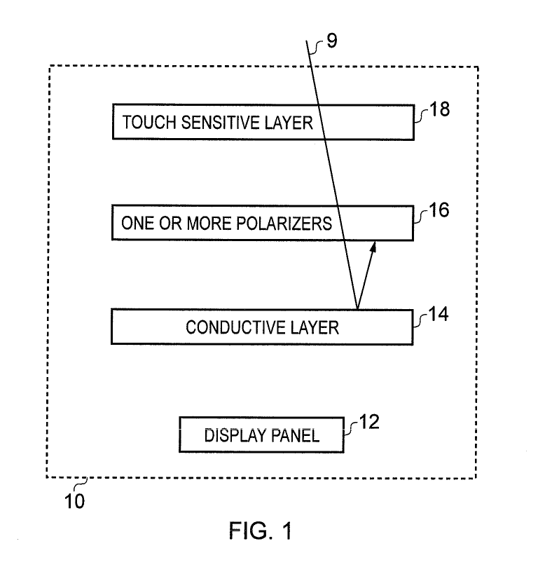

FIG. 1 illustrates a schematic of a first example of a display apparatus;

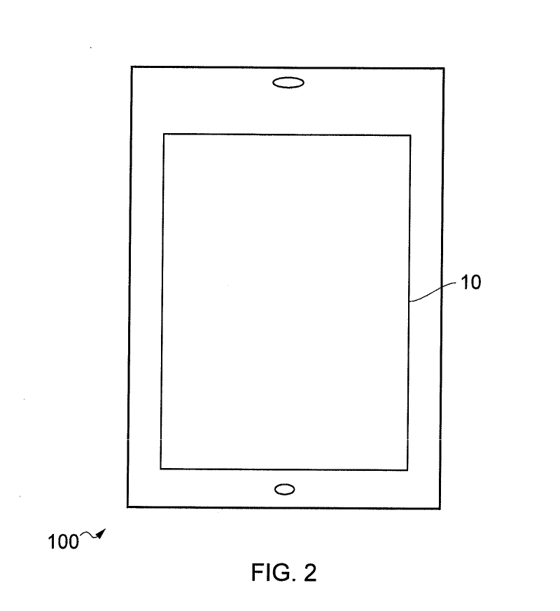

FIG. 2 illustrates a portable electronic apparatus comprising the display apparatus of FIG. 1;

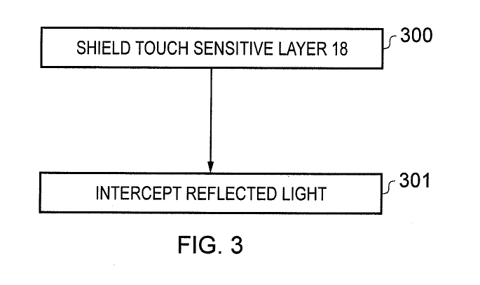

FIG. 3 illustrates a flow chart of a method;

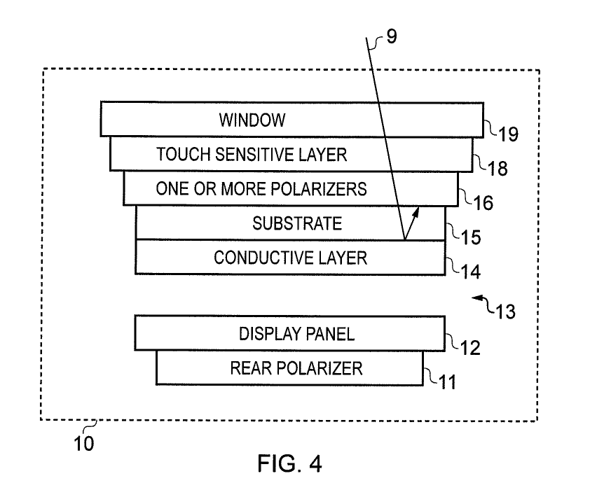

FIG. 4 illustrates a second example of the display apparatus; and

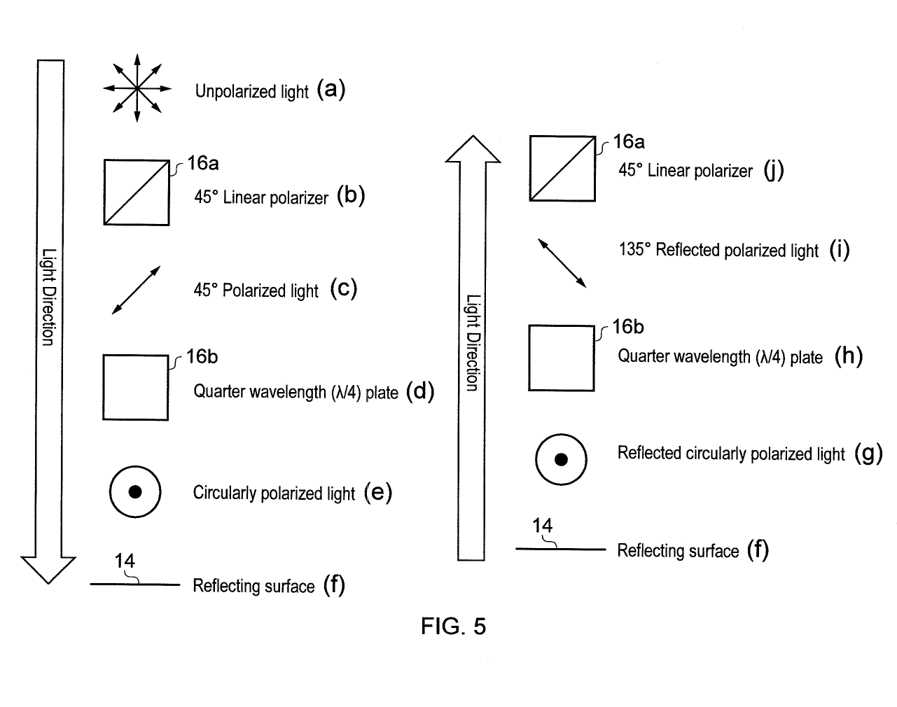

FIG. 5 illustrates a flow chart indicating how the polarization of light changes as it enters a display apparatus, reflects off a conductive layer of the display apparatus and is intercepted by one or more polarizers of the display apparatus.

### DETAILED DESCRIPTION

Embodiments of the invention relate to a display apparatus that comprises a touch sensitive layer and a conductive layer for shielding the touch sensitive layer, at least in part, from electromagnetic interference generated by a display panel.

The display apparatus also comprises one or more polarizers that intercept light reflected by the conductive layer. This advantageously prevents the reflected light from being seen by a viewer, or reduces the amount of reflected light that is seen by a viewer.

The figures illustrate an apparatus 10/100, comprising: a touch sensitive layer 18; a conductive layer 14 configured to shield, at least in part, the touch sensitive layer 18 from electromagnetic interference generated by a display panel 12; and one or more polarizers 16; 16a, 16b, situated at least partially between the touch sensitive layer 18 and the conductive layer 14, configured to intercept light that is directed towards a viewer of the display panel 12 after being reflected by the conductive layer 14.

FIG. 1 illustrates a schematic of a first example of a display apparatus 10. The display apparatus 10 may be a reflective, transmissive or transflective display apparatus 10. The apparatus 10 comprises a touch sensitive layer 18, one or more polarizers 16, a conductive layer 14 and a display panel 12.

The display panel 12 of the apparatus 10 comprises an array of pixels for displaying information content. The display panel 12 may, for example, be any type of display panel including: a liquid crystal display (LCD) panel, an organic light emitting diode (OLED) display panel or a quantum dot display panel.

The touch sensitive layer 18 is configured to detect touch input from a viewer/user of the apparatus 10. The touch sensitive layer 18 may be substantially transparent. A “touch input” includes inputs that are made by physical contact with the apparatus 10 (but not necessarily the touch sensitive layer 18 itself) using, for example, a digit or a stylus. It also includes inputs that are not made by physical contact with the apparatus 10, but are detected by the touch sensitive display 18 due to the proximity of an object (such as a digit or a stylus) to the apparatus 10.

The touch sensitive layer 18 may be any type of touch sensitive layer, such as a capacitive touch sensitive layer or a resistive touch sensitive layer.

The conductive layer 14 is configured to shield, at least in part, the touch sensitive layer from electromagnetic interference generated by the display panel 12. Electromagnetic interference may, for example, be generated when the display panel 12 is refreshed. The rate at which the display panel 12 is refreshed may vary from display panel to display panel. The rate may be multiple times per second and may, for instance, be 24 kilohertz or more.

The conductive layer 14 is arranged relative to the display panel 12 and the touch sensitive layer 18 such that it provides appropriate electromagnetic shielding. As illustrated schematically in FIG. 1, the conductive layer 14 may be positioned between the display panel 12 and the touch sensitive layer 18.

The conductive layer 14 may provide a reference potential for the touch sensitive layer 18. The touch sensitive layer 18 may, for example, be grounded via its electrical connection to the conductive layer 14.

The apparatus 10 further comprises one or more polarizers 16. The one or more polarizers 16 are configured to intercept light that is directed towards a viewer of the display panel 12, after being reflected by the conductive layer 14. The presence of the one or more polarizers 16 advantageously improves the optical performance of the display apparatus 10, because the viewer sees fewer (or no) reflections from the conductive layer 14.

The one or more polarizers 16 have one or more characteristics that enable them to at least partially block/intercept light that is reflected from the conductive layer 14. They are positioned relative to the conductive layer 14 such that they achieve this function. In the example illustrated in FIG. 1, the one or more polarizers 16 are at least partially situated between the conductive layer 14 and the touch sensitive layer 18. That is, either the whole or part of the one or more polarizers is situated between the conductive layer 14 and the touch sensitive layer 18.

FIG. 1 illustrates ambient light (in the form of ray 9) entering the apparatus 10, passing through the touch sensitive layer 18 and the one or more polarizers 16, reflecting off the conductive layer 14 and being intercepted by the one or more polarizers 16.

It will be appreciated by those skilled in the art that FIG. 1 is merely a schematic to illustrate embodiments of the invention. The presence of spaces in FIG. 1 between adjacent layers 12, 14, 16, 18 does not necessarily mean that there is an air gap between those layers 12, 14, 16, 18. There may or may not be air gap. There may or may not be one or more intervening elements/layers between the illustrated layers 12, 14, 16, 18.

FIG. 2 illustrates an electronic apparatus 100 comprising the display apparatus 10 illustrated in FIG. 1. The electronic apparatus 100 may, for example, be a hand portable electronic apparatus such as a mobile telephone, a portable music player, a games console or a tablet computer.

FIG. 3 illustrates a method according to embodiments of the invention. In block 300, the conductive layer 14 is used to shield, at least in part, the touch sensitive layer 18 from electromagnetic interference generated by the display panel 12.

Light travelling downwardly enters the apparatus 10 and is reflected upwards by the conductive layer 14. In block 301 of FIG. 3, the one or more polarizers 16 intercept the reflected light.

FIG. 4 illustrates a second example of a display apparatus 10. The apparatus 10 illustrated in FIG. 4 comprises a display panel 12, a conductive layer 14, one or more polarizers 16 and a touch sensitive layer 18, as in FIG. 1. The apparatus 10 of FIG. 4 also comprises a rear polarizer 11, an air cap 13, a substrate 15 and a window 19.

In the illustrated example, the display panel 12 is positioned between the rear polarizer 11 and the conductive layer 14. The rear polarizer 11 may, for example, be a linear polarizer.

The window 19 is positioned at the top of the display apparatus 10 in FIG. 4 and provides the outermost surface of the display apparatus 10. In the illustrated example, the touch sensitive layer 18 is situated adjacent the window 19 (that is, directly beneath the window 19) and between the window 19 and the one or more polarizers 16. In some embodiments there is no gap (nor any intervening elements) between the window 19 and the touch sensitive layer 18. The touch sensitive layer 18 may, for instance, be sputtered or laminated onto an inner surface of the window 19.

An air cap 13 is present between the display panel 12 and the conductive layer 14 in FIG. 4. This is optional. The air cap 13 is effectively a gap between the display panel 12 and the conductive layer 14. The display apparatus 10 may comprise one or more seals to prevent dust from entering the air cap 13.

In the FIG. 4 example, the conductive layer 14 is located on a substrate 15 which is different from the touch sensitive layer 18 and the one or more polarizers 16. The conductive layer 14 may, for instance, be a film located on the substrate 15. The substrate 15 may be located between the one or more polarizers 16 and the conductive layer 14.

The substrate 15 may be substantially optically isotropic. That is, the substrate 15 may have substantially the same optical properties in all directions (for example, substantially the same refractive index in all directions). The substrate 15 may, for example, be made from glass.

In FIG. 4, the one or more polarizers 16 separate the touch sensitive layer 18 from the substrate 15.

The one or more polarizers 16 may, for example, comprise a linear polarizer and a retarder/wave plate. The linear polarizer may be arranged relative to the wave plate (for example, above the wave plate) such that incoming light that is directed towards the conductive layer 14 passes through the linear polarizer, then the wave plate, before being reflected by the conductive layer 14. The reflected light passes through wave plate before being intercepted by the linear polarizer.

FIG. 4 illustrates incoming light 9 entering the display apparatus 10 via the window 19 and passing through the touch sensitive layer 18. The incoming light 9 is then polarized by the one or more polarizers 16 before it passes through the substrate 15. Since the substrate 15 is substantially optically isotropic, characteristics of the light 9 are not altered by the substrate 15. The polarized light 9 is then reflected by the conductive layer 14 before being intercepted by the one or more polarizers 16.

FIG. 5 relates to an example in the linear polarizer is a 45° linear polarizer 16a and the wave plate is a quarter wavelength plate 16b. FIG. 5 illustrates how the polarization of light changes as it travels through the display apparatus 10.

In part (a) of FIG. 5, unpolarized ambient light enters the window 19 of the display apparatus 10. The unpolarized light passes through the touch sensitive layer 18 before reaching the linear polarizer 16a in part (b) of FIG. 5. The 45° linear polarizer 16a ‘converts’ the unpolarized light to 45° (linearly) polarized light by absorbing a portion of the unpolarized light and allowing some to pass. Part (c) illustrates 45° polarized light emerging from the 45° linear polarizer 16a.

In part (d) of FIG. 5, the 45° polarized light reaches the quarter wavelength plate 16b. The quarter wavelength plate 16b creates a quarter-wavelength phase shift in the light, converting the 45° polarized light into circularly polarized light as illustrated in part (e).

In part (f) of FIG. 5, the circularly polarized light is reflected by the conductive layer 14, producing reflected circularly polarized light in part (g).

The reflected circularly polarized light travels in the direction of the window 19 and the viewer of the display apparatus 10. When the reflected circularly polarized light reaches the quarter wavelength plate 16b in part (h) of FIG. 5, it is ‘converted’ into 135° (linearly) polarized light (see part (i)). When the 135° polarized light reaches the 45° linear polarizer 16a in part (j) of FIG. 5, it is blocked/intercepted by the 45° linear polarizer 16a.

Thus, advantageously, reflections of ambient light from the conductive layer 14 of the display apparatus 10 are reduced or prevented in embodiments of the invention. This provides good optical performance.

A further advantage of the construction of FIG. 4 is that the conductive layer 14 is separated from the touch sensitive layer 18 by both the one or more polarizers 16 and the substrate 15. This enables touch sensitivity to be optimized/improved because there is a greater distance between the conductive layer 14 and the touch sensitive layer 18 (versus the touch sensitive layer 18 being separated from the conductive layer 14 by merely a substrate for the conductive layer 14).

A further advantage is that since the one or more polarizers 16 and the substrate 15 are being used to separate the conductive layer 14 from the touch sensitive layer 18 (rather than merely a substrate for the conductive layer 14), the thickness of the substrate 15 can be minimized.

The illustration of a particular order to the blocks/parts in FIGS. 3 and 5 does not necessarily imply that there is a required or preferred order for the blocks/parts and the order and arrangement of the blocks/parts may be varied. Furthermore, it may be possible for some blocks/parts to be omitted.

Although embodiments of the present invention have been described in the preceding paragraphs with reference to various examples, it should be appreciated that modifications to the examples given can be made without departing from the scope of the invention as claimed. For example, in some embodiments of the invention the conductive layer 14 may not merely reflect incoming light. It may also assist the one or more polarizers 16 with the manipulation of the incoming light to enable reflected light to be intercepted.

It will be apparent to those skilled in the art that the display apparatus 10 may include more polarizers than those illustrated in FIGS. 1 and 4.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus, comprising:
a touch sensitive layer;
a conductive layer configured to shield, at least in part, the touch sensitive layer from electromagnetic interference generated by a display panel; and
one or more polarizers, situated at least partially between the touch sensitive layer and the conductive layer, configured to intercept light that is directed towards a viewer of the display panel after being reflected by the conductive layer.

2. An apparatus as claimed in claim 1, wherein the conductive layer is located on a substrate which is different from the touch sensitive layer and the one or more polarizers.

3. An apparatus as claimed in claim 2, wherein the substrate is substantially optically isotropic.

4. An apparatus as claimed in claim 2, wherein the substrate is located between the touch sensitive layer and the conductive layer.

5. An apparatus as claimed in claim 2, wherein the one or more polarizers separate the touch sensitive layer from the substrate.

6. An apparatus as claimed in claim 1, wherein the one or more polarizers comprise a linear polarizer and a wave plate.

7. An apparatus as claimed in claim 6, wherein the linear polarizer is arranged relative to the wave plate such that incoming light directed towards the conductive layer passes through the linear polarizer and then subsequently passes through the wave plate prior to being reflected by the conductive layer, and such that light reflected by the conductive layer passes through the wave plate before being intercepted by the linear polarizer.

8. An apparatus as claimed in claim 1, further comprising a window, wherein the touch sensitive layer is situated adjacent the window.

9. An apparatus as claimed in claim 8, wherein there are no intervening elements between the window and the touch sensitive layer.

10. An apparatus as claimed in claim 1, wherein the electromagnetic interference is generated by refreshment of the display panel.

11. A method, comprising:
using a conductive layer to shield, at least in part, a touch sensitive layer from electromagnetic interference generated by a display panel; and
using one or more polarizers, situated at least partially between the touch sensitive layer and the conductive layer, to intercept light that is directed towards a viewer of the display panel after being reflected by the conductive layer.

12. A method as claimed in claim 11, wherein the conductive layer is located on a substrate which is different from the touch sensitive layer.

13. A method as claimed in claim 12, wherein the substrate is substantially optically isotropic.

14. A method as claimed in claim 12, wherein light reflected the conductive layer passes through the substrate before being intercepted.

15. A method as claimed in claim 11, wherein the touch sensitive layer is situated adjacent a window.

16. A method as claimed in claim 15, wherein there are no intervening elements between the window and the touch sensitive layer.

17. An apparatus, comprising:
touch sensing means;
shielding means for shielding, at least in part, the touch sensing means from electromagnetic interference generated by a display panel; and
means for intercepting light that is directed towards a viewer of the display panel after being reflected by the shielding means, wherein the means for intercepting light is situated at least partially between the touch sensitive layer and the conductive layer.

18. An apparatus as claimed in claim 17, wherein the shielding means is located on a substrate which is different from the touch sensing means and the means for intercepting light.

19. An apparatus as claimed in claim 18, wherein the substrate is substantially optically isotropic.

20. An apparatus as claimed in claim 18, wherein the means for intercepting light separates the touch sensing means from the substrate.
